(19) United States
(12) Patent Application Publication
(10) Pub. No.: US 2016/0104087 A1
(43) Pub. Date: Apr. 14, 2016

(54) SYSTEMS AND METHODS FOR MANAGING MASTER PROCESS PLANS

(71) Applicant: Caterpillar Inc., Peoria, IL (US)

(72) Inventors: Yamin Z. Mohammed, Peoria, IL (US); Joseph R. Herron, Farmington, IL (US)

(73) Assignee: Caterpillar Inc., Peoria, IL (US)

(21) Appl. No.: 14/509,280

(22) Filed: Oct. 8, 2014

(51) Int. Cl. G06Q 10/06

(52) U.S. Cl. CPC G06Q 10/06314; G06Q 10/06315

(57) ABSTRACT

A method for validating material requirements planning data is disclosed. The method includes receiving a first set of scheduling data from a first resource planning tool, receiving a second set of scheduling data from a second resource planning tool, performing a comparison of the first set of scheduling data and the second set of scheduling data, and generating a report based on the comparison.

### TECHNICAL FIELD

The present disclosure relates generally to master process plans and more particularly to methods and systems for managing master process plans. This disclosure allows for scheduling material requirements for production sequences to allow accuracy between the plan and system actual.

### BACKGROUND

Material requirements planning (MRP) tools are commonly used by a manufacturing enterprise for locating and gathering the required parts and/or components needed to build a desired end-product. MRP tools are often computerized automated applications that provide large corporations with purchasing, manufacturing, and supply chain related information. These applications provide a detailed list of the number of components that the corporation must acquire in order to manufacture its products. MRP tools are very useful in production sequences which may contain hundreds or thousands of individual components. Such applications coordinate the component needs for many diverse products, many of which may share components.

A conventional MRP tool may be a software (e.g., database) based applications that determines demand for parts (e.g., via part numbers) based upon input data (e.g., known demand for end-products containing the parts, predicted demand for end-products containing the parts, inventory of the parts, etc.). As input data changes, the MRP tool is run (i.e., executed) in a periodic fashion (e.g., once every planning cycle (e.g., ten business days)) to provide a constantly-updated planning and inventory control system for the manufacturing processes. In addition, such planning tools take into account component inventory and other sources of new and used components available for use. Once a material requirements plan is run, purchasing agents may act on the component purchasing reports and place orders accordingly. In addition, many MRP applications place orders with suppliers automatically. Therefore, it is important that the MRP be accurate and free of errors.

U.S. Pat. No. 6,681,141 to Ferreri, et al. describes a material planning simulation analysis method, but fails to describe a lead time validation process including comparing a sales model from an enterprise resource planning tool with a master process plan data from a workflow database. Ferreri, et al. also fails to describe identifying discrepancies to reduce overall lead times when performing materials planning.

Accordingly, the disclosed methods and systems are directed to solving one or more of the problems set forth above and/or other problems in the art.

### SUMMARY

In one aspect, a method of checking the accuracy of a material requirements planning (MRP) schedule is disclosed. The method includes receiving a first set of scheduling data from a first resource planning tool, receiving a second set of scheduling data from a second resource planning tool, performing a comparison of the first set of scheduling data and the second set of scheduling data, and generating a report based on the comparison.

In one aspect, a system for managing material requirements planning data is disclosed. The system includes an interface configured to receive a mismatch report generation selection and a processor operably connected to the at least one interface. Upon receiving the mismatch report generation selection by the interface, the processor receives a first set of scheduling data from a first resource planning tool, receives a second set of scheduling data from a second resource planning tool, performs a comparison of the first set of scheduling data and the second set of scheduling data, and generates a mismatch report based on the comparison.

In one aspect, a computer-readable medium including instructions for performing, when executed by a processor, a method for managing material requirements planning data, the method includes receiving a first set of scheduling data from a first resource planning tool, converting the first set of scheduling data from a first file format to a second file format, generating a factory calendar based on the converted first set of scheduling data, receiving a second set of scheduling data from a second resource planning tool, performing a comparison of the factory calendar and the second set of scheduling data, generating a report based on the comparison, and displaying the generated report.

Other features and aspects of this disclosure will be apparent from the following description and the accompanying drawings.

### BRIEF DESCRIPTION OF THE DRAWINGS

The accompanying drawings, which are incorporated in and constitute a part of this specification, illustrate several aspects of the disclosure and together with the description, serve to explain the principles of the disclosure. In the drawings:

FIG. 1 illustrates material requirements planning validation system according to embodiments of the present disclosure;

FIG. 2 illustrates a flowchart of method for validating a material requirements plan according to embodiments of the present disclosure;

FIG. 3 illustrates an interface for validating a material requirements plan according to embodiments of the present disclosure;

FIG. 4 further illustrates an interface for validating a material requirements plan according to embodiments of the present disclosure;

FIGS. 5A and 5B illustrate generated mismatch summaries according to embodiments of the disclosure;

FIG. 6 illustrates a generated mismatch snapshot according to embodiments of the disclosure; and

FIG. 7 illustrates a mismatch snapshot legend according to embodiments of the disclosure.

### DETAILED DESCRIPTION

Reference will now be made in detail to aspects of the disclosure, examples of which are illustrated in the accompanying drawings. Wherever possible, the same reference numbers will be used throughout the drawings to refer to the same or like parts or elements.

For purposes of this disclosure, the present system and method of validating material requirements and scheduling across multiple resource planning tools, as shown herein, are described in connection with planning tools used for determining material requirements for building machines, including machines such as off-highway mining trucks, hydraulic excavators, track-type tractor, wheel loaders, component facilities, and the like. However, the disclosed system and method are equally well-suited for use with any other systems for creating material requirements plans, master schedules and the like. Furthermore, the present disclosure may refer to analysis of information collected from one or more planning tools relating to a sub-system, sequence, or process of building one type of machine or a plurality of different machines.

With respect to the above products, short, reliable lead-times allow companies in the production supply chain to wait longer before committing to production plans. The result of waiting longer is that there is less opportunity for circumstances to change or, equivalently, more schedule stability. In this environment, a powerful, easy to use scheduling tool coupled with the availability of complete information can greatly decrease waste in the supply chain. Accordingly, the present disclosure provides such a tool, together with methods for enabling use of the tool.

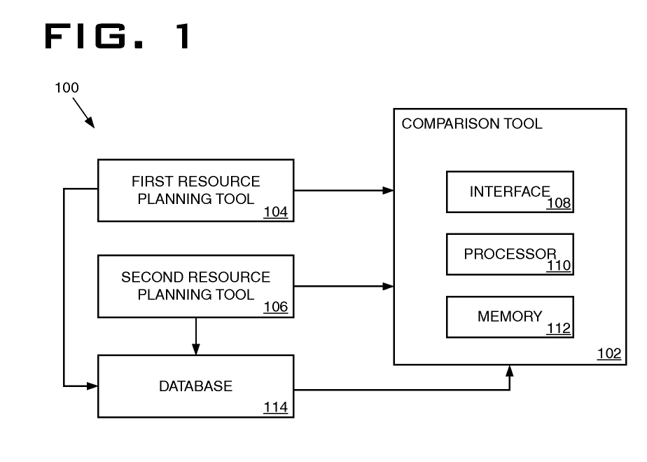

FIG. 1 illustrates a material requirements validation system 100 (hereinafter also referred to as system 100) according to embodiments of the present disclosure. Embodiments of the disclosure provide a mechanism for comparing material requirements planning data (MRP) data from two or more resource planning tools and identifying discrepancies between the data from the resource planning tools. Due to disparate formats and underlying programming of resource planning tools, discrepancies between the master process plans managed by the tools may be difficult to diagnose. The disclosed systems and methods may integrate data from different resource planning tools, to enable resource planners to coordinate production in a timely fashion, and achieves the objects of increasing productivity, lowering inventory and ensuring compliance with one or more production strategies (e.g., Just-In-Time (JIT)/Lean Manufacturing strategies). JIT may be defined as a production strategy for improving businesses that reduces in-process inventory and associated carrying costs. The system 100 may thus manage MRP processes by allowing discrepancies to be quickly and efficiently resolved prior to ordering of materials. Accordingly, overall lead time for scheduling material reorders may be reduced.

The system 100 shown in FIG. 1 includes a comparison tool 102, which may be operably connected to one or more resource planning tools 104, 106. The comparison tool 102 and the one or more resource planning tools 104, 106 may be server tools or client tools and may be accessible via a mainframe, desktop, laptop, network computer, workstation, personal digital assistant (PDA), tablet PC, or the like. The comparison tool 102 and the one or more resource planning tools 104, 106 may be connected by a network (e.g., a telephone-based network (such as PBX or POTS), a local area network (LAN), a wide area network (WAN), the Internet or another packet-switched network, a dedicated intranet, a workstation peer-to-peer network, a direct link network, a wireless network, or another suitable network).

The comparison tool 102 may be a modified version of a spreadsheet tool such as Microsoft® Excel or Google® Sheets, Adobe® or a like spreadsheet tool. The comparison tool 102 may include an interface 108, which may be operably connected to the one or more resource planning tools 104, 106. The interface 108 may enable communication with the one or more resource planning tools 104, 106 via the above described network. The interface 108 may be a graphical user interface (GUI) configured to display on an electronic display including, but not limited to, an LCD, CRT, plasma display, or the like, and may include. The interface 108 may include one or more selectable controls (and one or more selectable sub-controls) that may be activated via an input device such as a keyboard, touch screen, or any like input device that may be used to interface with the comparison tool 102.

The comparison tool 102 may include a processor 110 that may communicate with the resource planning tools 104, 106 to perform a comparison of resource planning tool data as described herein. The processor 110 may include one or more known processing devices, such as a microprocessor from the Pentium™ or Xeon™ family manufactured by Intel™, the Turion™ family manufactured by AMD™, or any other type of processor.

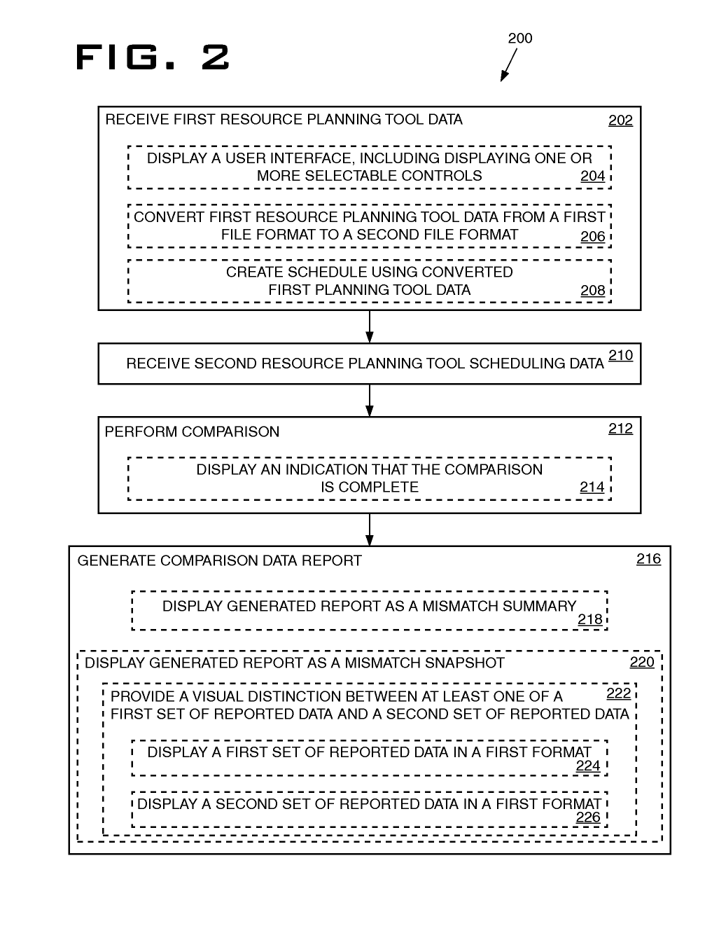

In embodiments, the comparison tool 102 includes a memory 112 that may include one or more programs or subprograms loaded from the storage device or elsewhere that, when executed by the processor 110, perform various procedures, operations, or processes consistent with disclosed embodiments. For example, the memory may include one or more programs that enable the processor 110 to, among other things, perform comparisons between data received from resource planning tools, as discussed below in detail with respect to FIG. 2. Memory 112 may be a volatile or non-volatile, magnetic, semiconductor, tape, optical, removable, non-removable, or other type of storage device or computer-readable medium.

In some embodiments, data from one or more of the resource planning tools 104, 106 may be gathered and stored in a database 114, to be used in the embodiments disclosed herein. The database 114 may be configured to store various types of data, including generated mismatch reports. In some embodiments, the database 114 may include one or more storage devices configured to store information or data, such as the mismatch reports discussed above, which can be used by the processor 110 to perform certain functions related to the disclosed embodiments. Database 114 may include a volatile or non-volatile, magnetic, semiconductor, tape, optical, removable, non-removable, or other type of storage device or computer-readable medium. Database 114, or another storage device (not shown) operably connected to the processor 110, may store programs and/or other information, such as information related to processing data.

The first resource planning tool 104 may be an enterprise resource planning tool. The first resource planning tool 104 may be configured to manage a master process plan for scheduling material requirements according to current and future planned changes. In some embodiments, the first resource planning tool 104 is an enterprise resource planning (ERP) program such as the ERP program provided by SAP.

The second resource planning tool 106 may be different from the first resource planning tool and may be a data visualization or process flow tool configured to provide a visual representation of a master process plan for scheduling material requirements according to current and future planned changes. In some embodiments, the second resource planning tool is Microsoft® Visio, SmartDraw®, or a like diagramming or process flow visualization tool. While the first and second resource planning tools are described herein as an enterprise resource planning tool and a data visualization or process flow tool, respectively, the reverse is also contemplated, as is the use of other resource planning tools not specifically described herein.

It is with the above described system in mind that one or more methods for validating material requirements planning and scheduling data are contemplated. To this end, FIG. 2 is a flowchart of a method 200 for validating material requirements planning data. It is contemplated that method 200 may be performed in any order suitable for validating material requirements planning data according to embodiments of the disclosure. The method 200 is described for illustration purposes only with respect to the systems and interfaces depicted in FIGS. 1 and 3-7. However, it should be apparent that the method 200 may be employed with other systems and interfaces. Further, the order of operations of FIG. 2 should not be considered limiting.

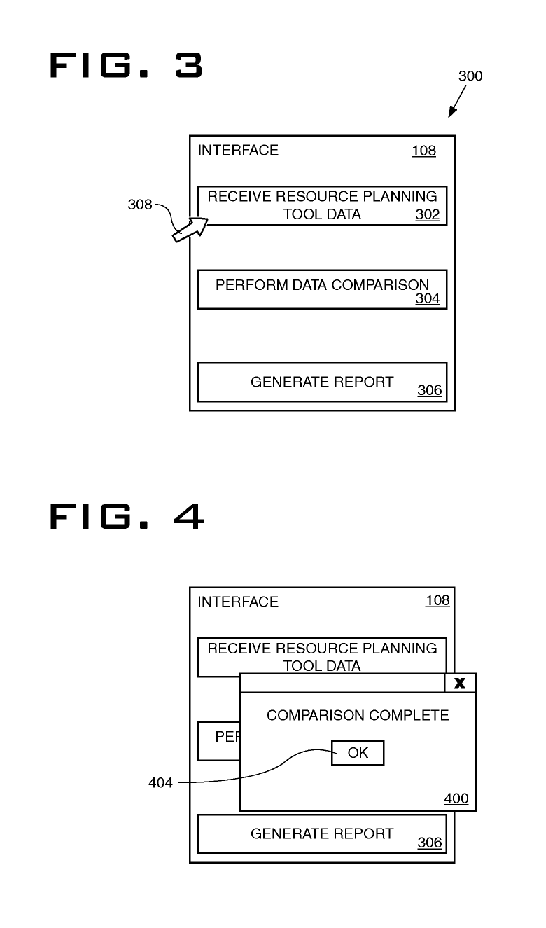

Method 200 may begin at operation 202, where first resource planning tool data is received. For instance, referring to FIG. 1, first resource planning tool data may be received by the comparison tool 102. First resource planning tool data may be exported or retrieved from the first resource planning tool 104 upon request from the comparison tool 102. First resource planning tool data may be requested by the comparison tool 102 via the interface 108. Accordingly, in some embodiments, the method 200 includes displaying 204 a user interface including one or more selectable controls for initiating the receiving of the first set of scheduling data and the second set of scheduling data. As shown in FIG. 3, the interface 108 may display one or more selectable controls 302-306, including at least one control for initiating data retrieval from one or more resource planning tools (e.g., receive resource planning tool data control 302). In such embodiments, a first set of scheduling data may be received upon selection of receive resource planning tool data control 302 (e.g., using a pointer 308).

In some embodiments, first resource planning tool data may be enterprise resource planning (ERP) tool data. As discussed above, an ERP tool may be a tool configured to calculate capability and material planning as references for decision makers. In some embodiments, first resource planning tool 104 is configured to maintain data regarding material requirements, scheduling requirements and the like as they pertain to building a master schedule for component delivery and distribution. For example, a factory producing a multi-component product may maintain an inventory of materials needed for each component, a delivery schedule for materials needed for a given production stage, and a process schedule outlining the process flow for constructing a product or any subassemblies of the product for a given production stage. These inputs may be entered into a first resource planning tool routing schedule.

The received data may include existing customer orders for an end-products and/or subassemblies, forecast customer orders for end-products and/or subassemblies, etc. Such data may be obtained in any suitable conventional manner, such as, for example, by gathering customer order data from a database and/or using historical data to predict future customer orders. In implementations, the data received in operation 202 may be associated with a bill of material (BOM) that identifies part numbers and/or subassemblies of part numbers associated with the product(s). In embodiments, the data is stored in at least one database (e.g., database 114) that is accessible by the ERP tool.

First resource planning tool data may be saved in a first file format (e.g., the file format of first resource planning tool 104), or may be converted to (or saved in) a different format (e.g., portable document format (PDF)) prior to retrieval of the first resource planning tool data by the comparison tool 102. In instances where the file format of the comparison tool differs from the file format of the received first resource planning tool data, the method 200 may proceed to operation 206, where the first resource planning tool data is converted to a second file format. For instance, the comparison tool 102 may convert received first resource planning tool data from a received file format (e.g., PDF) to a second file format (e.g., text). Conversion may be performed for compatibility or ease of processing by the comparison tool 102.

Following retrieval and/or conversion of the retrieved first resource planning tool data, the method 200 may proceed to operation 208, where a material requirements schedule is created in the file format of the comparison tool 102 (e.g., Excel). The material requirements schedule may be based on the converted first resource planning tool data. In some embodiments, the material requirements schedule may be a factory calendar. The factory calendar may define working and non-working days and may also include company specific dates such as holidays, alternate working days, shutdown days, etc.

The method 200 may then proceed to operation 210, where second resource planning tool data is received. As shown in FIG. 1, second resource planning tool data may be received by the comparison tool 102. Second resource planning tool data may be exported or retrieved from the second resource planning tool 106. As with the first resource planning tool data, second resource planning tool data may be requested by the comparison tool 102 via the interface 108, either as a separate command, concurrently with, or after the request for first resource planning tool data.

Second resource planning tool data may be data visualization tool data (e.g., data input into a visualization tool such as Microsoft® Visio). Second resource planning tool data may be a material requirements plan. The material requirements plan may be a production plan for finished products spanning a period of time in the future. The material requirements plan for a product or sequence may be prepared using planned orders in a true multi-level optional component scheduling environment. Accordingly, the material requirements schedule may also be based on existing customer orders and a medium-term aggregate production plan. The material requirements schedule may include parameters such as forecast demand, production costs, inventory costs, lead time, working hours, capacity, inventory levels, available storage, and parts supply. The aim of the material requirements plan is to timely forward the finished products to relevant customers, while avoiding overloading or underutilization of production apparatus and production capacity. Usually, a manufacturer makes purchase orders according to production demand, buffer inventory and lead time, and transmits the purchase orders to corresponding vendors to obtain the necessary raw materials and components. The vendors provide the raw materials and components to the manufacturer according to the purchase orders. Changes in market supply and demand cause much uncertainty in production demand, and purchase orders frequently need to be changed or re-scheduled. If the purchase orders are not re-scheduled methodically and timely, this can lead to delays in supply of the raw materials and components, and consequent delays in production.

In some embodiments, the interface 108 of the comparison tool 102 may display a message (e.g., via a pop-up or overlay interface) indicating that the first resource planning tool data and the second resource planning tool data have been received and/or processed. Upon completion of the receive and/or convert operations, the method 200 may then proceed to operation 212, where a comparison of the material requirements schedule generated from the first resource planning tool data and the material requirements plan generated from the second resource planning tool data is performed using the file format of the comparison tool 102.

To proceed to one or more next operations in the validation process, the interface 108 may include a control for initiating the performing of the comparison of the first set of scheduling data and the second set of scheduling data. For instance referring back to FIG. 3, a user may select a perform data comparison control 304. Upon selection of the control 304, the data included in the schedule generated from the first resource planning tool data may be compared against data included in the master process plan generated using the second resource planning tool, and discrepancies between the two sets of data may be detected. In some embodiments the method 200 includes displaying 214 an indication that the comparison is complete. The indication that a comparison has completed may be displayed visually in an overlay interface or dialog box. For instance, as shown in FIG. 4, a dialog box 400 may display over the interface. The dialog box 400 may indicate that the comparison is complete. A selectable control (e.g., OK control 402 may also be provided to acknowledge completion of the comparison and/or to exit out of dialog box 400)

Following detection of any discrepancies, a comparison report may be generated and may display. In some instances, a selectable control may be provided within interface 300 to initiate comparison report generation (e.g., generate report control 306). Method 200 may then proceed to operation 216, where a report including discrepancies between the converted first resource planning tool data and the second resource planning tool data is generated. A generated report may be displayed in separate a pop-up window, in a separate tab of the comparison tool interface, etc. In embodiments, both master data and a report may be generated upon request for each sequence in a current MRP cycle. In this manner, anomalies that arise from incorrect (e.g., erroneous) input data to the resource planning tools may be quickly identified and rectified.

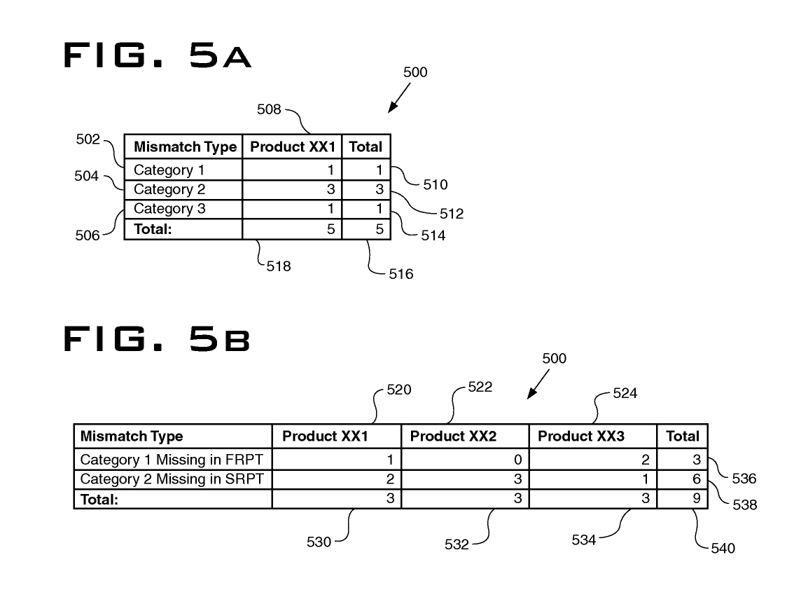

The comparison report may be available for display in a plurality of formats. For instance, a generated report may include one or more of a mismatch summary and a mismatch snapshot for each sequence. FIGS. 5A and 5B illustrate examples of a first generated report 500 displayed in a first display format according to aspects of the disclosure. A first display format may be a mismatch summary. Displaying the report in this manner may include displaying 218 a summary of one or more mismatches between the first set of scheduling data and the second set of scheduling data for one or more products. For instance, as can be seen in FIG. 5A, a plurality of mismatch categories (e.g., mismatch categories 502, 504, 506) may display in a first column, and a number of corresponding anomalies may display in a second column underneath a product heading 508 and a totals columns 510, 512, 514, 516, 518 may be provided for each product or sequence and each category. Another example of a mismatch summary is displayed in FIG. 5B. As shown in FIG. 5B, a plurality of products may be provided in individual product columns 520, 522, 524. A more detailed description may also be provided for each mismatch type (e.g., Category 1 Missing in FRPT 526, Category 2 Missing in SRPT 528), where FRPT stands for “first resource planning tool,” and SRPT stands for “second resource planning tool.” Totals columns 530, 532, 534, 536, 538, 540 may also be provided for each product or sequence, each mismatch type and for all mismatches for all products.

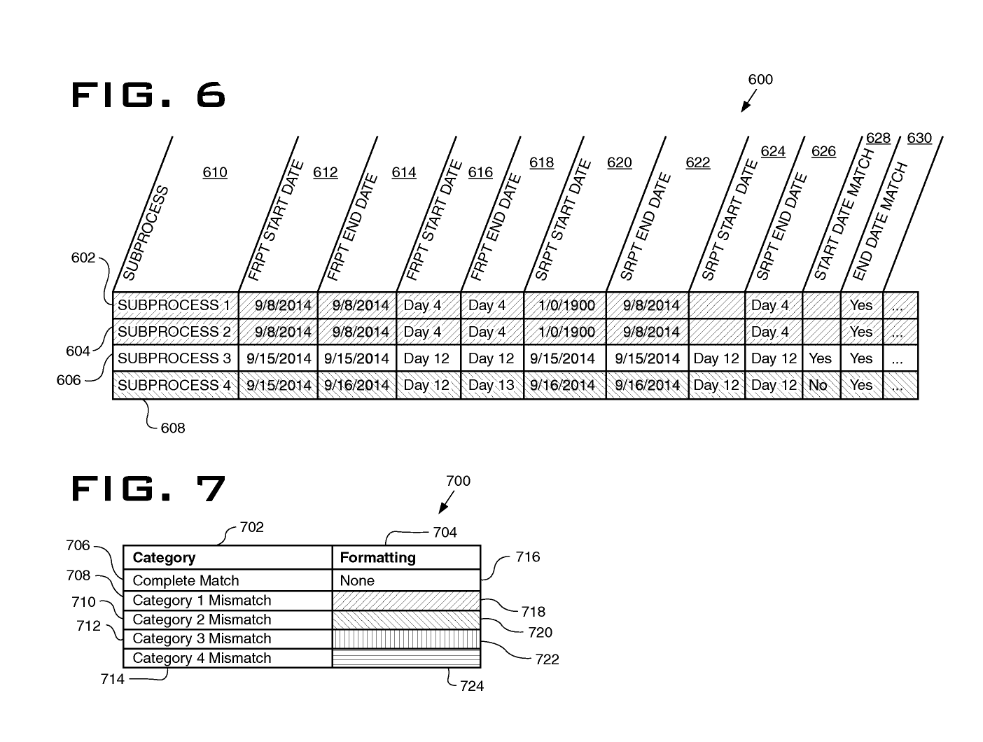

FIG. 6 illustrates an example of a second generated report 600 displayed in a second display format according to aspects of the disclosure. A second display format for the comparison report may be a mismatch snapshot. Displaying the report in this manner may include displaying 220 a snapshot of one or more mismatches between the first set of scheduling data and the second set of scheduling data. Generally, displaying the report as a mismatch snapshot may include providing 222 a visual distinction between at least one of a first set of reported data and a second set of reported data. For instance, displaying the report may include displaying 224 a first set of reported data in a first format. In such instances, the first set of reported data includes non-mismatched scheduling data. Displaying the report may also include displaying 226 a second set of reported data in a second format. The second set of reported data includes mismatched scheduling data. As will be described with respect to FIGS. 6 and 7, it is further contemplated that mismatched data may be further subcategories into one or more mismatch category, and each mismatch category may have an associated displayed format.

FIG. 7 illustrates a legend 700 that a user may be able to reference to quickly identify mismatches for one or more categories of scheduling information, for example, dates, locations, start times, end times, etc. Referring back to FIG. 6, a plurality of rows and columns may display. A first column (e.g., Subprocess column 610 may include one or more rows for one or more subprocesses (e.g., Subprocess 1 602, Subprocess 2 604, Subprocess 3 606, Subprocess 4 608, etc.) for a given production sequence. For each subprocess row, a plurality of requirements planning categories (e.g., FRPT Start Date 612, FRPT End Date 614, FRPT Start Day 616, FRPT End day 618, SRPT Start Date 620, SRPT End Date 622, SRPT Start Day 624, SRPT End day 626, etc.), and a plurality of requirements planning match categories (e.g., Start Day Match 628, End Day Match 630, etc.) may be displayed. A displayed row may be formatted (e.g., highlighted in a particular color) to visually represent either a match or a specific mismatch category. For instance, as can be seen in the example illustrated in FIG. 6, the row for Subprocess 1 602 may be formatted in a particular manner (in this instance, forward slashes may represent a first type of formatting, which may be any of a cell color, text color, typeface or font, text accentuation such as bolding or underlining, etc.). Referring to the legend 700 of FIG. 7, the particular formatting of a given row may be associated with a respective mismatch type. The legend 700 may include a Category column 702 including a plurality of mismatch categories (e.g., Complete Match 706, Category 1 Mismatch 708, Category 2 Mismatch 710, Category 3 Mismatch 712, and Category 4 Mismatch 714). An adjacent formatting column 704 may illustrate the corresponding formatting 716, 718, 720, and 722 for each mismatch category. Thus, the particular formatting of the first row (Subprocess 1 602) may refer to a first category mismatch (Category 1 Mismatch 708) (e.g., a start day is missing for Subprocess 1). Continuing with this example, the row for Subprocess 3 606 may be formatted in a different particular manner (in this instance, no formatting may represent a second type of formatting). Referring to the legend 700 of FIG. 7, the particular formatting of the third row (Subprocess 3 606) may refer to a complete match (e.g., a complete match of data for Subprocess 3). Further continuing with this example, the row for Subprocess 4 608 may be formatted in a manner different from the above referenced rows (in this instance, backward slashes may represent a third type of formatting, which may be any of a cell color, text color, text accentuation such as bolding or underlining, etc., different from the first and second type or formatting). Referring to the legend 700 of FIG. 7, the particular formatting of the fourth row (Subprocess 4 608) may refer to a second category mismatch (e.g., a start date mismatch Subprocess 4). Additional category mismatches categories and corresponding formatting are contemplated. Further, the system and method described above are not limited by the examples provided with respect to FIGS. 6 and 7.

In some embodiments, method 200 may also include displaying a selectable update report control for updating the report upon correction of the mismatched data entry. In this manner, comparison report may be interactive, in that a user may correct mismatches or anomalies by selecting a mismatch. In some embodiments, the second set of reported data may include one or more selectable individual entries linked to the first set of scheduling data in the first resource planning tool and the second set of scheduling data in the second resource planning tool to enable correction of a mismatched data entry in either the first resource planning tool or the second resource planning tool. Upon selection the user may be directed to the underlying resource planning tool to view the mismatch and make a correction, if needed.

Embodiments of the disclosure are configured to track and validate the scheduling of a sequence across a sales model of a respective organization. The report and improved validation process allow users to quickly and efficiently identify and correct errors in the MRP cycle. While the operations of the flow diagram described herein may be implemented in the system of FIG. 1, the operations of the flow diagram may be implemented and executed from a server, in a client-server relationship, or may run on a user workstation with operative information conveyed to the user workstation. Additionally, the disclosure can take the form of an entirely hardware embodiment, an entirely software embodiment or an embodiment containing both hardware and software elements. In an embodiment, the software elements include firmware, resident software, microcode, etc.

Operations consistent with embodiments of the present disclosure may be performed by one or more programmable processors executing a computer program to perform functions of the disclosure by operating on input data and generating output. Operations can also be performed by an apparatus consistent with the disclosure can be implemented as, special purpose logic circuitry, e.g., an FPGA (field programmable gate array) or an ASIC (application-specific integrated circuit).

To provide for interaction with a user, embodiments of the disclosure can be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the disclosure can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the disclosure, or any combination of such back-end, middleware, or front-end components. The components of the system can be interconnected by any form or medium of digital data communication, e.g., a communication network. Examples of communication networks include a local area network (LAN) and a wide area network (WAN), e.g., the Internet.

### INDUSTRIAL APPLICABILITY

The disclosed systems and methods provide tools for improving MRP data quality. Material requirements data may be better understood and validated prior to the live execution of a MRP run for material demands. To increase the robustness of a MRP, data from two or more resource planning tools may be input into a comparison tool to provide future materials planning and scheduling. The first resource planning tool may be an enterprise resource planning tool and the second resource planning tool one may be a process flow visualization tool. The comparison tool may receive data from the resource planning tools and identify discrepancies between the two sets of data. Accordingly, the comparison tool enhances customer serviceability, by improving component availability and reducing part shortages. It also reduces inventory overages caused by planning errors (input errors). The system and method described herein may benefit any MRP environment by improving data integrity which directly impacts inventory dollars and customer serviceability.

The embodiments of the present disclosure may be applied to various applications While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for validating material requirements planning data comprising:
receiving a first set of scheduling data from a first resource planning tool;
receiving a second set of scheduling data from a second resource planning tool;
performing a comparison of the first set of scheduling data and the second set of scheduling data; and
generating a report based on the comparison.

2. The method of claim 1, wherein the first resource planning tool is one of an enterprise resource planning tool or a data visualization tool.

3. The method of claim 1, wherein the second resource planning tool is different from the second resource planning tool and is one of an enterprise resource planning tool or a data visualization tool.

4. The method of claim 1, wherein the comparison tool is a spreadsheet tool.

5. The method of claim 1, further comprising:
converting the first set of scheduling data from a first file format to a second file format.

6. The method of claim 5, further comprising:
generating a factory calendar using the converted first set of scheduling data.

7. The method of claim 4, further comprising:
displaying a user interface including:
displaying one or more selectable controls for initiating the receiving of the first set of scheduling data and the second set of scheduling data; and
displaying a selectable control for initiating the performing of the comparison of the first set of scheduling data and the second set of scheduling data.

8. The method of claim 1, further comprising:
displaying an indication that the comparison is complete.

9. The method of claim 1, further comprising:
displaying the generated report.

10. The method of claim 9, wherein displaying the generated report comprises:
displaying at least one of a summary of one or more mismatches between the first set of scheduling data and the second set of scheduling data and a snapshot of one or more mismatches between the first set of scheduling data and the second set of scheduling data.

11. The method of claim 9, wherein displaying the generated report comprises:
providing a visual distinction between a first set of reported data and a second set of reported data, wherein the first set of reported data includes non-mismatched scheduling data and the second set of reported data includes mismatched scheduling data.

12. The method of claim 11, wherein the visual distinction includes at least one of a color, a typeface, or a text accentuation.

13. The method of claim 11, wherein the second set of reported data includes one or more selectable individual entries linked to the first set of scheduling data in the first resource planning tool and the second set of scheduling data in the second resource planning tool to enable correction of a mismatched data entry in either the first resource planning tool or the second resource planning tool.

14. The method of claim 13, further comprising:
displaying a selectable update report control for updating the report upon correction of the mismatched data entry.

15. A system for validating material requirements planning data comprising:
an interface configured to receive a mismatch report generation selection; and
a processor operably connected to the at least one interface, wherein, upon receiving the mismatch report generation selection by the interface, the processor:
receives a first set of scheduling data from a first resource planning tool;
receives a second set of scheduling data from a second resource planning tool;
performs a comparison of the first set of scheduling data and the second set of scheduling data; and
generates a mismatch report based on the comparison.

16. The system of claim 15, wherein the first resource planning tool is one of an enterprise resource planning tool or a data visualization tool, and the second resource planning tool is different from the second resource planning tool and is one of an enterprise resource planning tool or a data visualization tool.

17. The system of claim 15, wherein the interface is further configured to:
display an indication that the comparison is complete; and
display the generated mismatch report, further comprising at least one of:
displaying a summary of one or more mismatches between the first set of scheduling data and the second set of scheduling data; and
displaying a snapshot of one or more mismatches between the first set of scheduling data and the second set of scheduling data.

18. The system of claim 17, wherein displaying the generated mismatch report comprises:
providing a visual distinction between a first set of reported data and a second set of reported data, wherein the first set of reported data includes non-mismatched scheduling data and the second set of reported data includes mismatched scheduling data.

19. The system of claim 18, wherein the interface is further configured to display the second set of reported data as one or more selectable individual entries, and the processor is further configured to link to the one or more selectable individual entries to at least one of the first set of scheduling data in the first resource planning tool and the second set of scheduling data in the second resource planning tool to enable correction of a mismatched data entry in either the first resource planning tool or the second resource planning tool.

20. A computer-readable medium including instructions for performing, when executed by a processor, a method for validating material requirements planning data, the method comprising:
receiving a first set of scheduling data from a first resource planning tool;
converting the first set of scheduling data from a first file format to a second file format;
generating a factory calendar based on the converted first set of scheduling data;
receiving a second set of scheduling data from a second resource planning tool;
performing a comparison of the factory calendar and the second set of scheduling data;
generating a report based on the comparison; and
displaying the generated report.
